(19) United States
(12) Patent Application Publication
(10) Pub. No.: US 2014/0095896 A1
(43) Pub. Date: Apr. 3, 2014

(54) EXPOSING CONTROL OF POWER AND CLOCK GATING FOR SOFTWARE

(71) Applicants: Nicholas P. Carter, Hillsboro, OR (US); Joshua B. Fryman, Corvallis, OR (US); Robert C. Knauerhase, Portland, OR (US); Aditya B. Agrawal, Urbana, IL (US); Josep Torrellas, Urbana, IL (US)

(72) Inventors: Nicholas P. Carter, Hillsboro, OR (US); Joshua B. Fryman, Corvallis, OR (US); Robert C. Knauerhase, Portland, OR (US); Aditya B. Agrawal, Urbana, IL (US); Josep Torrellas, Urbana, IL (US)

(21) Appl. No.: 13/630,738

(22) Filed: Sep. 28, 2012

(51) Int. Cl. G06F 1/26

(52) U.S. Cl. 713/300

(57) ABSTRACT

A processor includes at least one power domain, each power domain including at least one core that switchably receives power supply from a voltage regulator and switchably receives a clock signal from a clock source, a cache, and at least one control registers having stored thereon data indicating power management states of the at least one power domain and the cache.

### FIELD OF THE INVENTION

The present disclosure pertains to managing the power consumption of processors, in particular, to mechanism that may allow the software to control the power consumption at fine scales.

### BACKGROUND

Power management is an important aspect of processors. Power management may reduce the power consumption of processors, and thus reduce the power consumption cost and increase the use time of a battery. However, power management mechanism may also have costs. For example power management may reduce microprocessor performance and may stall an application when the application tries to use a processor unit that has been powered off. For these reasons, systems that incorporate power management mechanism may predict the behavior of applications being executed in order to reduce power consumption or to power off units that may not be needed while keeping units that will be used in power.

### DESCRIPTION OF THE FIGURES

Embodiments are illustrated by way of example and not limitation in the Figures of the accompanying drawings:

FIG. 1 is a block diagram of a system according to an embodiment of the present invention.

FIG. 2 is a microprocessor according to an embodiment of the present invention.

FIG. 3 is a register interface for controlling power management according to another embodiment of the present invention.

FIG. 4 is a process of accessing a register interface for power management according to an embodiment of the present invention.

### DETAILED DESCRIPTION

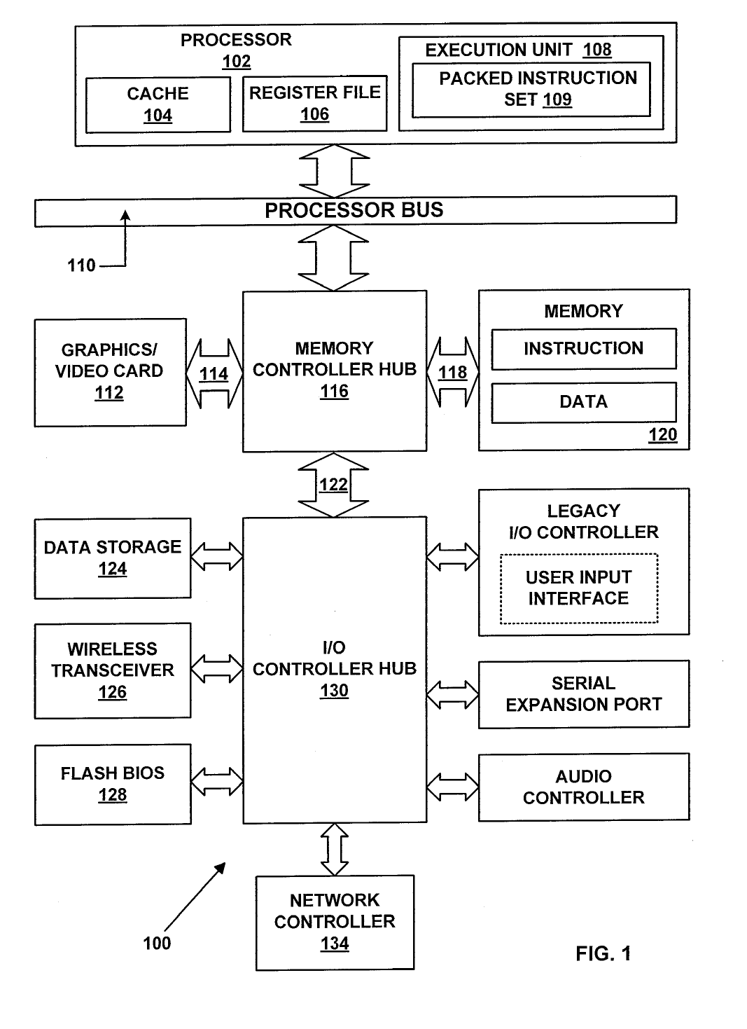

Embodiments of the present invention may include a computer system as shown in FIG. 1. The computer system 100 is formed with a processor 102 that includes one or more execution units 108 to perform an algorithm to perform at least one instruction in accordance with one embodiment of the present invention. One embodiment may be described in the context of a single processor desktop or server system, but alternative embodiments can be included in a multiprocessor system. System 100 is an example of a ‘hub’ system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register.

Execution unit 108, including logic to perform integer and floating point operations, also resides in the processor 102. The processor 102 may also include a microcode (ucode) ROM that stores microcode for certain macroinstructions. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 may be coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

Embodiments of the present invention may include a processor including a core and a dedicated control register having stored thereon data indicating a power management state of the core.

Embodiments of the present invention may include a processor including at least one power domain, each power domain including at least one core that switchably receives power supply from a voltage regulator and switchably receives a clock signal from a clock source; a cache, and at least one dedicated control register having stored thereon data indicating power management states of the at least one power domain and the cache.

Embodiments of the present invention may include a processor including (1) a first block of control registers having stored thereon first data indicating power management states of power domains of the processor; (2) a second block of control registers having stored thereon second data indicating power management states of one or more caches of the processor; and (3) a third block of control registers having stored thereon third data indicating power management of each core in the power domains of the processor.

Embodiments of the present invention may include a method including in response to a request for a power management state of a hardware unit in a processor, retrieving the power management state from a corresponding control register; computing a target power management state for the hardware unit based on the retrieved power management state for the hardware unit; and storing the target power management state to the corresponding control register.

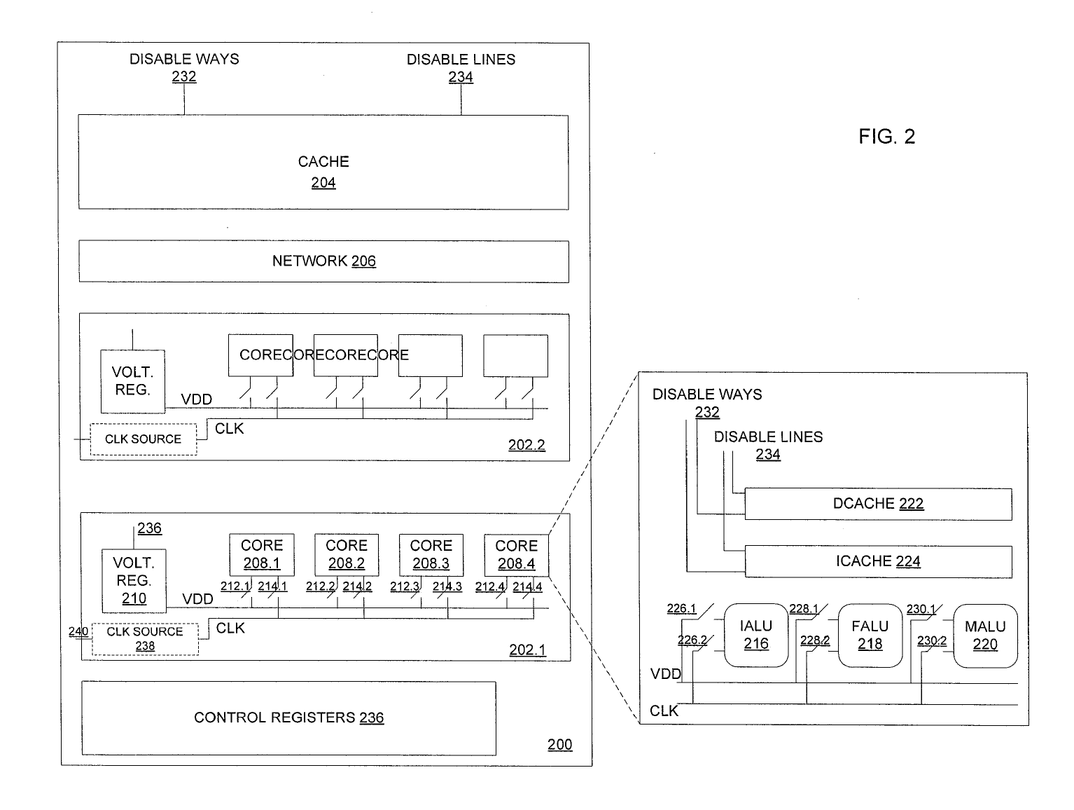

FIG. 2 illustrates a microprocessor that includes power management mechanism according to an embodiment of the present invention. A microprocessor 200 (such as a CPU or GPU) may include one or more power domains 202.1, 202.2, one or more caches 204, a network fabric 206, and a set of control registers 236. Each domain may include one or more cores that are supplied with a clock signal and powered through a voltage regulator. For example, the power domain 202.1 may include cores 208.1-208.4 and a voltage regulator 210 that supplies a voltage Vdd to these cores. A clock source 238 (which may be external) may supply a clock signal (CLK) to these cores as well. The cores in the power domains 202.1, 202.2 may be connected to cache 204 via the network 206 so that cores may load or store instructions and/or data in the cache 204. In one embodiment, the cache may also divided into power domains that include different voltage regulators supplying power. Alternatively, the cache 204 may be, as shown in FIG. 2, a single block of cache memory that is shared by all of the power domains. Data may be copied from memory in blocks of cache lines. The cache lines may be written to specified cache ways.

Power management may be achieved by clock gating and power gating either the cores or the cache. Clock gating is a method of disabling the clock signal (CLK) supplied to a core during a gated period of time, thereby eliminating active power consumption. While clock gating may eliminate active power consumption, clock gating does not eliminate the DC power consumption. Thus, clock gating may “leak” power while the clock signal is disabled. Power gating stops the power supply to a core, and thus eliminate all power consumptions of the core. However, power gating a core may destroy the states of the core as well, which may stall the core and require a “wake-up” period when later the core is to be used again. To avoid the stall caused by power gating, software applications may need to ensure that all hardware units they use are activated in advance before their actual usage.

The voltage regulator 210 may include a control input 236 that may receive a voltage control word that may include one or more bits. Based on the bits of the voltage control word, voltage regulator 210 may be set to either normal voltage operation or the power gated state. Further, the voltage control word may include one or more bits to set Vdd voltage value to the cores. For example, the voltage Vdd may be set within a range of 1-2 volts. Similarly, the clock source 238 may include a control input 240 that may receive clock control word that may include one or more bits. Based on the bits of the clock control word, clock source 238 may be set to either normal clock operation or the clock gated state. Further, the clock control word may include one or more bits to set clock rate to the cores. The clock rate may be within a range that is less or equal to a maximum clock rate.

Clock gating and power gating may be achieved by switches that control the supply of clock signal (CLK) or power (Vdd) in each domain. As shown in FIG. 2, in an embodiment, each domain may include respective switches 212.1-212.4 connecting between the voltage regulator 210 and the each core 208.1-208.4, and include respective switches 214.1-214.4 connecting between the clock source 240 to the cores 208.1-208.4. Switches 212.1-212.4 may be controlled by a respective power gating signal for the core. Thus, if the power gating signal is off, the corresponding switch 212.1-212.4 may be engaged and Vdd is supplied to the corresponding core (i.e., the core is in normal power operation). However, if the power gating signal is on, the corresponding switches 212.1-212.4 may be disengaged and the corresponding core is powered off (i.e., the core is in a power gated state). Similarly, switches 214.1-214.4 may be controlled by a respective clock gating signal for the core. Thus, if the clock gating signal is off; the corresponding switches 214.1-214.4 may be engaged and the clock signal (CLK) is supplied to the corresponding core (i.e., the core is in normal clock operation). However, if the clock gating signal is on, the corresponding switches 214.1-214.4 may be disengaged and the corresponding core is shut off clock signal (CLK) (i.e., the core is in a clock gated state). Therefore, by controlling switches 212.1-212.4 and 214.1-214.4, each of the cores may operate in any of normal, power gated, or clock gated states.

Power management mechanism may also manage the usage of caches. Caches at all levels in the memory hierarchy may have the capability of disabling individual lines and/or ways to adjust the capacity and associativity of the cache to meet the objectives of power consumption based on the needs of the application. As shown in FIG. 2, each cache 204 may include a first control terminal 232 for receiving a way control signal for selectively controlling the enablement/disablement of the cache ways, and include a line control terminal 234 for receiving a second control signal for selectively controlling the enablement/disablement of the cache lines. The way control signal and the line control signal may be gated signals. If the gated signal is off, the corresponding cache way or line may be enabled for normal operation. However, if the gated signal is on, the corresponding way or line may be disabled for power management.

Selected cache lines may be disabled in conjunction with reconfiguration of the hit/miss logic of the cache. For example, in an embodiment, half of cache lines may be turned off in response to the status of an indicator bit to make the cache appear to the outside as one having half of the original capacity.

In an alternative embodiment, the cache lines or ways may be disabled by requiring that the software application to refrain from issuing any memory references to the disabled line or ways. In yet an alternative embodiment, cache lines or ways may be disabled by clock gating (e.g., disabling the clock to the logic that drives the lines or ways), or by power gating (e.g., removing the power supply to the lines or ways, which may destroy data stored in the lines or ways), or by “drowsy cache”—i.e., retaining data stored in the lines or ways but requiring a “wake-up” period before the line or ways may be used again.

Embodiments of the present invention may also include power management mechanism that control the power and clock supplies to components inside each core. As shown in FIG. 2, a core 208 may include an integer arithmetic logic unit (IALU) 216, a floating-point arithmetic logic unit (FALU) 218, a memory arithmetic logic unit (MALU) 220 or other types of execution units, a D-cache 222, and an I-cache 224. The IALU 216 may be supplied with power (Vdd) through switch 226.1 and clock signal (CLK) through switch 226.2; the FALU 218 may be supplied with power (Vdd) through switch 228.1 and clock signal (CLK) through switch 228.2; the MALU 220 may be supplied with power (Vdd) through switch 230.1 and clock signal (CLK) through switch 230.2. D-cache 222 may include a line control terminal for receiving a line control signal and a way control terminal for receiving a way control signal. Thus, IALU 216, FALU 218, and MALU 220 may be individually switched to normal operation, power gating, or clock gating state through the control of switches 226.1, 226.2, 228.1, 228.2, 230.1, 230.2. If switches 226.1, 226.2, 228.1, 228.2, 230.1, 230.2 are all engaged, IALU 216, FALU 218, and MALU 220 may be in the normal operational state. If any of switches 226.1, 228.1, 230.1 are disengaged, the corresponding IALU 216, FALU 218, and MALU 220 may operate in the power gating state. Similarly, if the any of switches 226.2, 228.2, 230.2 are disengaged, the corresponding IALU 216, FALU 218, and MALU 220 may operate in the clock gating state. Ways and lines in D-cache 222 and I-cache 224 may be individually disabled by the way control signal and line control signal as applied to the way control terminals and line control terminals of D-cache 222 and I-cache 224.

As discussed above, the power management mechanism as described above may have different costs and benefits. The change of the supply voltage and clock rate of certain domains may yield energy savings because of the quadratic relationship between supply voltage and power consumption. Clock gating may be turned on and off quickly, often in a single clock cycle. However, clock gating only reduces active power consumption, leaving leakage power untouched. Power gating may completely eliminate a circuit unit's power consumption, but any important state information in the circuit unit may need to be saved and later restored when the circuit is power gated off or on. The saving and restoration of state information may impose a performance and energy cost to power gating. Therefore, to achieve the optimal power management, application may need to solve complex control problems, taking into consideration not only cores and cache as a whole but also components within each core. This may require the application to have easy access to the status of each core and cache, and the components therein. Also, the application may need an interface to easily change the power operational states of domains, cores, cache and components in a CPU. Embodiments of the present invention provide a set of control registers 236 having stored thereon data indicating the power management states of each hardware units. Because of the set of dedicated control registers 236, software programs may easily access, including read or write, the power management states of hardware units.

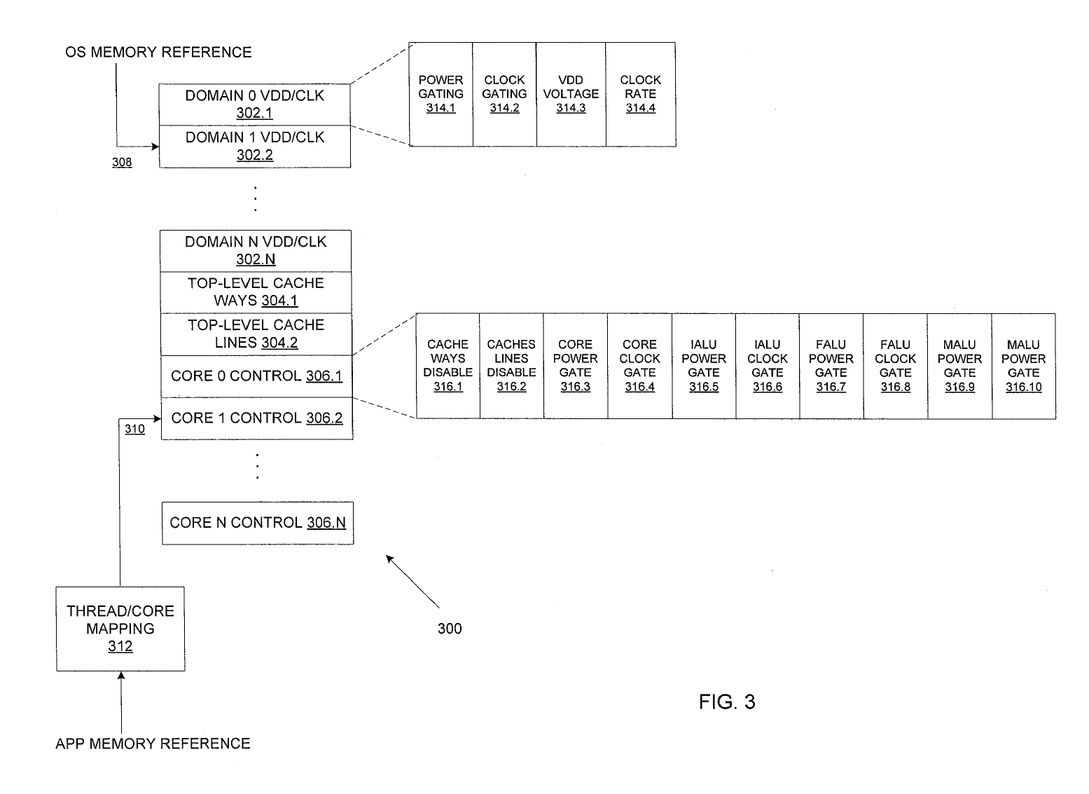

Embodiments of the present invention may create a register interface in a processor including a set of memory-mapped control registers that allow a software application to interact with hardware components for power management purpose. In one embodiment, the control registers are dedicated for storing power management states of hardware units. FIG. 3. is a register interface 300 for controlling power management according to an embodiment of the present invention. The register interface may include one or more registers that may include bits to indicate power management status. The registers may be divided into blocks, each block including status information for a different level of hardware. In an embodiment as shown in FIG. 3, the register interface 300 may include a first block 302 of registers for managing power at domain levels, a second block 304 of registers for top-level cache, and a third block 306 of registers for core power management control.

The first block 302 of registers may include one or more registers 302.1-302.N, each of which may indicate the power management status of a corresponding power domain. In one embodiment, each of the one or more registers may further include a first bit for indicating power gate status and a second bit for indicating clock gate status. For example, register 302.1 may include a first bit 314.1 which indicates the domain 0 should be in power gating if the first bit is ON (or =“1) and should not be in power gating if the first bit is OFF (or =“0”). The register 302 may include a second bit 314.2 which indicates the domain 0 should be in clock gating if the second bit is ON and should not be in clock gating if the second bit is OFF. Register 302.1 may further include third bits 314.3 indicating the voltage of Vdd, and forth bits 314.4 indicating a clock rate for CLK. Therefore, each domain may set its own Vdd and/or CLK. In one embodiment, bits 314.1, 314.3 may form the voltage control word that may be supplied to the control input (such as 236) of the voltage regulator (such as 210), bits 314.2, 314.4 may form the clock control word that may be supplied to the control input (such as 240) of the clock source (such as 238).

The second block 304 may include a first register 304.1 for ways in the top-level cache (L3 level, e.g., cache 204 as shown in FIG. 2) and a second register 304.2 for lines in the top-level cache. Register 304.1 may include a plurality of bits each of which may indicate the power management status of a corresponding way. If a bit of register 304.1 is ON/OFF, the corresponding way may be disabled/enabled. Similarly, register 304.2 may include a plurality of bits each of which may indicate the power management status of a corresponding line. If a bit of register 304.2 is ON/OFF, the corresponding line may be disabled/enabled.

The third block 306 of registers may include one or more registers 306.1-306.N, each of which may include the power management status of a corresponding core. In one embodiment, each register may include a plurality of bits for indicating the power management status of components inside the core. For example, in one embodiment, a register may include bits for cache ways disable 316.1, cache lines disable 316.2, core power gate 316.3, core clock gate 316.4, IALU power gate 316.5, IALU clock gate 316.6, FALU power gate 316.7, FALU clock gate 316.8, MALU power gate 316.9, and MALU clock gate 316.10. Bits 316.1 and 316.2 may indicate enablement/disablement of ways and lines of caches inside the corresponding core. Bits 316.3 and 316.4 may respectively indicate power gate and clock gate states of the core. Bits 316.5 and 316.6 may respectively indicate power gate and clock gate states of IALU of the core. Bits 316.7 and 316.8 may respectively indicate power gate and clock gate states of FALU of the core. Bits 316.9 and 316.10 may respectively indicate power gate and clock gate states MALU of the core. Therefore, a register in the third block may indicate the power management status of a core including components therein.

Software programs including both the operating system (OS) and applications may have access to the control register interface 300. In one embodiment, the OS may have the right to access all of the registers in the register interface 300 through a pointer 308. For accessing each register in the register interface 300, the OS may reference the address of the specific register that the OS intends to access via pointer 308. Applications, on the other hand, may only have the right to access part of the registers of the register interface 300. Therefore, applications may not directly reference each register of the register interface 300. Instead, the applications may access the register interface 300 through a thread and core mapping module 312 which may include a lookup table that may map an application visible thread ID onto the set of control registers corresponding to the set of hardware executing the thread. The thread and core mapping module 312 may first prevent the application from de-activating hardware that is in use by other applications because the lookup table will block any attempts to affect hardware that is not allocated to the application. The thread and core mapping module 312 may secondly separate resources that are visible to an application (or threads of the application) from the specific hardware being used to execute those threads. This separation may make it easy for the hardware and/or operating system to migrate these application threads among cores because the application does not need to know which core a thread is running on.

The OS and applications may issue load operations (i.e., read from the register interface) that target these control registers in order to learn the current power management state of units in the system. Based on the power management state of units in the system, the OS and applications may include a power management module that calculates when to switch the power management state of a unit in the system. The OS and applications may issue a store operation to the control registers in the register interface to change the hardware unit's power management configuration. For example, a store operation that writes a “1” to a bit of a control register in the register interface may instruct the corresponding hardware unit to start to power on or to start to supply clock to the hardware unit. Conversely, a store operation that writes a “0” to a bit of a control register in the register interface may instruct the corresponding hardware unit to start to power off or to start to disable clock to the hardware unit.

In one embodiment, the OS and application software may issue a read operation to the register interface. The read operation may be implemented to inquire and return the actual power management state of the corresponding hardware unit. The actual power management state, in practice, may be different from the indicated power management state that is being stored in the corresponding control register. This kind of scenarios may occur in the following situations. For example, when software issues a request for a unit to be powered on, a load operation of that control register may continue to return a state of “0” (off) until the unit has completely powered on and is available for use. Also, there may be situations where the hardware on its own decides to overrule a software request. For example, software requests that a processor be powered on, but the processor is already at its thermal limit. In such a situation, the readable value of the control register may not change until the hardware is able to comply with the request. Depending on the implementation, attempts to use a unit before it is ready may stall the program or cause an application error.

In one embodiment, the status of registers between register blocks may be inter-related. For example, if a domain is indicated powered-off, the cores within the domain would be indicated powered-off as well. Cores within the domain may be indicated powered-on only when the domain of the cores is powered on. Similarly, if a core is indicated powered-off, the hardware units within the core would be indicated power-off as well. Hardware units within the core may be indicated power-on only when the core of the hardware units is powered on.

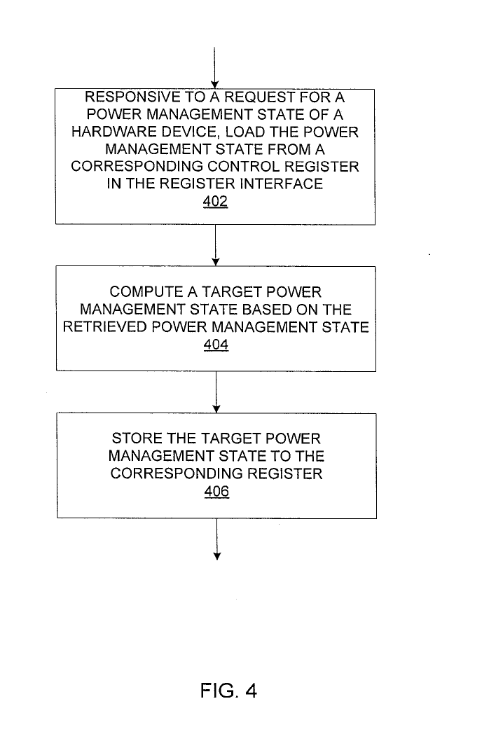

FIG. 4 is a process of using the register interface for power management according to an embodiment of the present invention. A computing unit (such as a core) may be configured to perform the process. At 402, in response to a request for a power management state of a hardware device (including domains, cores, and units within cores), the computing unit may be configured to load the power management state from a control register that is designated for storing the power management state of the hardware device. At 404, the computing unit may subsequently compute a target power management state based on anticipated operations and the current power management state. The target power management state may or may not be the same as the current power management state. If they are not the same, the computing unit may be configured to store the target power management state to the corresponding control register, thus causing the start of the change of the power management state of the hardware device. In one embodiment, the computing unit may load multiple or all bits of a control register, thus loading the power management states of multiple hardware devices in parallel. The computing unit may predict the target power management states of the multiple hardware devices based, in part, on all of the loaded the power management states. Subsequently, the computing unit may issue a store operation to the control register to change the power management states of the multiple hardware devices.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor, comprising:
a core, and
a control register having stored thereon data indicating a power management state of the core.

2. The processor of claim 1, wherein the control register is dedicated for storing the power management state of the core.

3. The processor of claim 2, wherein the core is configured to switchably receive a power supply, and switchably receive a clock signal, and wherein the power management state of the core includes a power-gated state when the power supply is switched off and a clock-gated state when the clock signal is switched off.

4. The processor of claim 3, wherein the processor is configured to execute a load operation that retrieves the power management state of the core from the control register.

5. The processor of claim 4, wherein the processor is configured to execute a power management module that calculates a target power management state of the core based on the retrieved power management state.

6. The processor of claim 3, where the processor is configured to execute a store operation that writes a target power management state to the control register.

7. The processor of claim 6, wherein in response to the target power management state is written in the control register, the core is switched to the target power management state.

8. The processor of claim 1, wherein the core further includes at least one of an integrated arithmetic unit (IALU), a floating-point arithmetic unit (FALU), and a memory arithmetic unit (MALU), and wherein each of the at least one of the IALU, FALU, and MALU is switchably receives a power supply and a clock signal.

9. The processor of claim 8, wherein the control register further having stored thereon data indicating the power management state of each of the at least one of the IALU, FALU, and MALU is switchably receives a power supply and a clock signal.

10. The processor of claim 9, wherein the power management state of each of the at least one of the IALU, FALU, and MALU includes a power-gated state when the power supply is switched off and a clock-gated state when the clock signal is switched off.

11. A processor, comprising:
at least one power domain, each power domain including at least one core that receives an adjustable power supply from a respective voltage regulator and receives an adjustable clock signal from a clock source; and
at least one control register having stored thereon data indicating power management states of the at least one power domain.

12. The processor of claim 11, further comprising:
a cache,
wherein the at least one control register is dedicated for storing the power management states of the power domains and the cache.

13. The processor of claim 12, wherein the cache includes ways and lines, and wherein the cache further includes
a first input for receiving a first signal that controls enablement and disablement of the ways, and
a second input for receiving a second signal that controls enablement and disablement of the lines.

14. The processor of claim 13, wherein the at least one control register further stores data indicating enablement and disablement of the ways and lines of the cache.

15. The processor of claim 14, wherein the processor is configured to execute a load operation that retrieves the power management states of the power domain and the enablement and disablement of the cache, and wherein the processor is configured to execute a power management module that calculates a target power management state of the at least one domain based on the retrieved power management state.

16. The processor of claim 14, wherein the processor is configured to execute a store operation that writes a target power management state to the control register, and wherein in response to the target power management state is written in the control register, the at least one domain is switched to the target power management state.

17. The processor of claim 14, wherein the control register is divided into blocks including a first block for storing power management states of the at least one power domains, a second block for storing power management states of the cache, and a third block for storing the power management states of each core in the at least one power domains.

18. A processor, comprising:
a control register interface including:
a first block of control registers having stored thereon first data indicating power management states of power domains of the processor;
a second block of control registers having stored thereon second data indicating power managements of cache of the processor; and
a third block of control registers having stored thereon third data indicating power management of each core in the power domains of the processor.

19. The processor of claim 18, wherein the processor is configured to execute a load operation for retrieving the first, second, and third data based on which the processor calculates a target power management state for one of the power domains, cache, and each core of the power domains.

20. The processor of claim 18, wherein the processor is configured to execute a store operation for writing a target power management state to one of the first block, the second block, and the third block of control registers.

21. A method, comprising:
in response to a request for a power management state of a hardware unit in a processor, retrieving the power management state from a corresponding control register;
computing a target power management state for the hardware unit based on the retrieved power management state for the hardware unit; and
storing the target power management state to the corresponding control register.
